(19) United States
(12) Patent Application Publication
(10) Pub. No.: US 2013/0250117 A1
(43) Pub. Date: Sep. 26, 2013

(54) Automated Tool Control System

(71) Applicants: Steve Pixley, Santa Ana, CA (US); James McMahon, Santa Ana, CA (US); Dean Vail, Western Grove, AR (US)

(72) Inventors: Steve Pixley, Santa Ana, CA (US); James McMahon, Santa Ana, CA (US); Dean Vail, Western Grove, AR (US)

(21) Appl. No.: 13/430,615

(22) Filed: Mar. 26, 2012

(51) Int. Cl. H04N 7/18

(52) U.S. Cl. 348/156; 348/143; 348/E07.085

(57) ABSTRACT

The invention pertains to a digital camera system and related software which is capable of identifying the presence or absence of known tools and/or objects in previously identified storage locations as well as the presence of non-conforming objects. The invention further includes controlled access

### CROSS-REFERENCE TO RELATED APPLICATIONS

None

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### SEQUENCE LISTING

Not applicable

### BACKGROUND OF THE INVENTION

### Field of the Invention

Foreign objects and debris (FOD) left or deposited on airport runways, tarmacs and/or within aircraft engines, instrument clusters or air frames can cause damage costing enormous amounts of money and in worst case conditions cause catastrophic failure of the aircraft and possible loss of life.

Organizations, both private and military have established specialized rules and procedures to minimize and reduce the occurrence of foreign objects and debris (FOD) on runways and inside of aircrafts. This practice is usually referred to as foreign object elimination or FOE.

The monitoring of tools and tool inventory in aircraft maintenance and repair facilities is a critical aspect of minimizing and/or eliminating these misplaced tools. Many facilities have persons whose job it is to manually inspect tool chests at the end of each shift to formally certify or validate that all of the tools that have been assigned to each tool chest have been returned.

Initial means to facilitate proper tool inventory include tagging each tool with a bar code or a radiofrequency identification (RFID) tag. These procedures typically required the manual placement of each tool in proximity to a bar code or RFID reader. In addition to this time-consuming step was all of the record keeping, logging and tagging that were part of the initial tool inventory.

These and other means have been described in issued patents:
a) marking tools in multiple locations with machine readable information that can't be worn away—U.S. Pat. No. 6,915,592.
b) tagging tools with resonance frequency tags—U.S. Pat. No. 4,720,907.
c) marking tools with both electronic tags and with two-dimensional dot matrix codes—U.S. Pat. No. 6,840,451

All the above require that the tools be either marked or tagged with additional components which is both time-consuming and expensive as well as provide various electronic devices to detect and track the tags.

### BRIEF SUMMARY OF THE INVENTION

The present invention is a tool storage, control and tracking system that uses a digital video subsystem to record and verify the presence or absence of the tools stored inside one or more multi-tray tool storage cabinets. This tool system is designed to automatically verify that all tools assigned to a specific tool control cabinet are placed in the specific designated location(s) within a designated tray within a specific tool control cabinet. The primary application of the present invention is the implementation of FOD control in an aircraft maintenance environment, where 100% tool accountability is required.

Though a typical embodiment combines the digital video subsystem with a computer-based access controlled multi-tray tool cabinet, the digital video subsystem could be implemented in a more stand-alone fashion wherein the controlled access is not as important, but tool auditing is important. Such an environment might be in a hospital operating room where all the surgical tools need to be accounted for to make sure none have been left in a patient.

As used herein, references to tool or tools shall be understood to also include other objects or articles that need to be tracked and/or inventoried.

Tool control in this environment consists of several main concerns. The first is that there is controlled access to tools stored in the tool control system. This limits access to certain tool control cabinets to only those workers who have been assigned to certain locations, certain projects and/or have specified security clearances. The second and more critical concern is the capability of the tool control cabinets to perform an automatic tool audit which means that a tool control cabinet can automatically confirm that all tools which have been assigned to a particular tool control cabinet have been returned, not only to the tool control cabinet itself, but also to an assigned tool tray and location.

The simplest tool control system would be a single stand-alone tool control cabinet which would provide local auditory or visual signals regarding the verification status of that specific tool control cabinet after an audit. Alternative embodiments of the tool control system could include two or more tool control cabinets in electrical communication with a central server and optionally in electrical communication with several servers and optionally in electrical communication with the Internet. Such electrical communication could utilize both wired and wireless communication protocols.

Various embodiments of the tool control system can cover a wide range of capabilities of tool auditing. One relatively simple embodiment would be to have the tool control system perform a tool audit only when initiated manually by a user. More sophisticated embodiments would initiate the audit procedure based upon time of day or by a remote wired or wireless communication signal. Other embodiments would have sophisticated user tracking and tool monitoring and would initiate an audit at the end of each user's session at the system.

### BRIEF DESCRIPTION OF THE SEVERAL VIEWS OF THE DRAWING

FIG. 1 is a external perspective view of one embodiment of the present invention with the front maintenance door open;

FIG. 2 is a perspective view of the embodiment shown in FIG. 1 with the front access door closed;

FIG. 3 shows a typical tray containing tools and the two layers of foam;

FIG. 4 shows a single camera board that is part of the camera assembly;

FIG. 5 shows perspective view of the left side of the internal tray transport mechanism;

FIG. 6 shows an expanded portion of FIG. 5 with one of the trays removed to enhance visibility;

FIG. 7 show a perspective view of the right side of the internal tray transport mechanism;

FIG. 8 shows an expanded portion of FIG. 7;

FIG. 9 shows a perspective view the internal tray transport mechanism with all trays removed to enhance visibility;

FIG. 10 shows the internal transport mechanism and the upper cabinet which houses the camera assembly; and

FIG. 11 shows an expanded portion of FIG. 10 with a portion of the upper cabinet shown as transparent in order to view the camera and the microcontroller board.

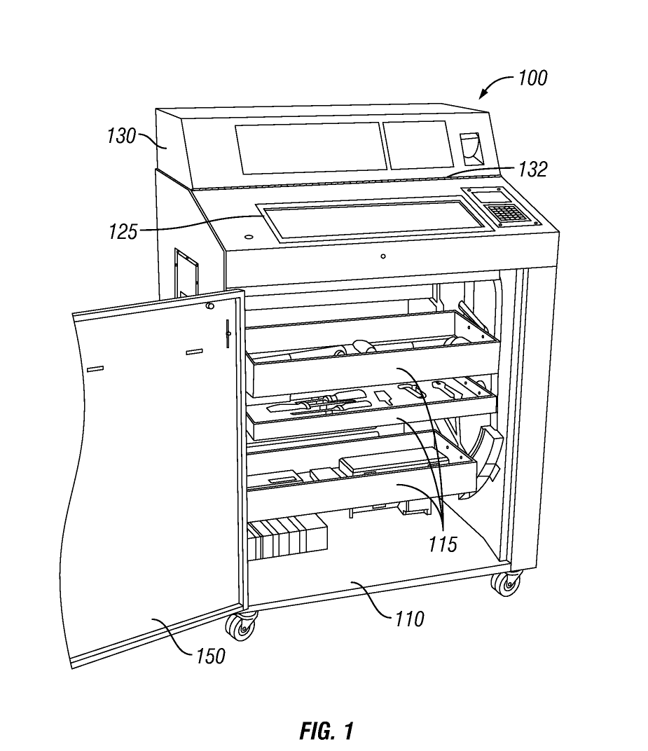

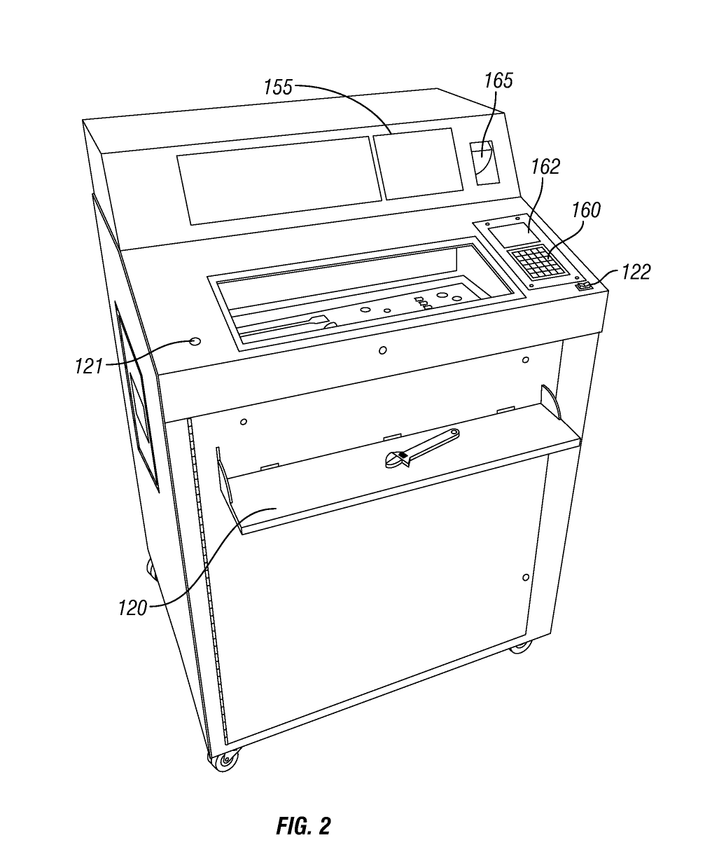

### DETAILED DESCRIPTION OF ONE EMBODIMENT OF THE INVENTION

Individual tools are stored in cavities formed by two layers of foam which are placed within tools trays stored within each tool control cabinet. The cavity is formed by cutting out a portion of the Upper Foam Layer 175. The foam cut-outs are generally in the shape of the tool which facilitates not only the proper placement of the tool when replaced within the tool control cabinet, but also facilitates the auditing process by the camera assembly, which will be described later in further detail. The Upper Foam Layer 175 is one color which is referred to as the foreground color and the Lower Foam Layer 180 is a different color, which is referred to as the shadow color.

It is necessary that the foreground color and the shadow color are different. Using black as a shadow color is not a good choice because there is so little light reflected that is takes too much time for the auto-balancing feature of most cameras to become stabilized. Though black as a foreground color is usable, other colors are preferred and red is the most preferred color for the shadow color.

Foreground and shadow colors can be different for each camera. In the standard configuration where four cameras are utilized, there can be four different sections in any one tray, each section having the same or different foreground and background colors in order to optimize the detection of different colored tools. This reduces or eliminates the need to color tag or in other ways alter the appearance of tools. The aim is to utilize the tools as they come from the manufacturer.

However, instead of standard drawers which slide out, the tool control cabinet of the present invention has the trays attached to a motorized chain drive transport system, arranged similarly to a Ferris wheel. The trays are attached to the transport system such that they will remain more or less parallel to the ground as they are transported along a pair of generally oval tracks located on each side of the main cabinet. The transport control system can control with great precision the placement of each of the trays along the oval transport track.

There are two special locations along the track. The first location is generally underneath controlled Access Door 125 located on the upper front portion of the Cabinet 110. When proper authorization has been granted by the access computer, the Access Door latch is released. Access Door 125 can be opened and the user is now able to access the tray, for the addition or removal of tools from the tray immediately below the Access Door. The transport system can be operated while Access Door 125 is open to provide a worker with access to all of the trays and all of the tools stored in that particular tool control cabinet. For enhanced safety, the tray mechanism can only be moved when a pair of switches, located outside of and on opposite sides of the cabinet, are actuated. This generally would require that both hands of the user are positioned outside of the cabinet and away from moving portions of the device.

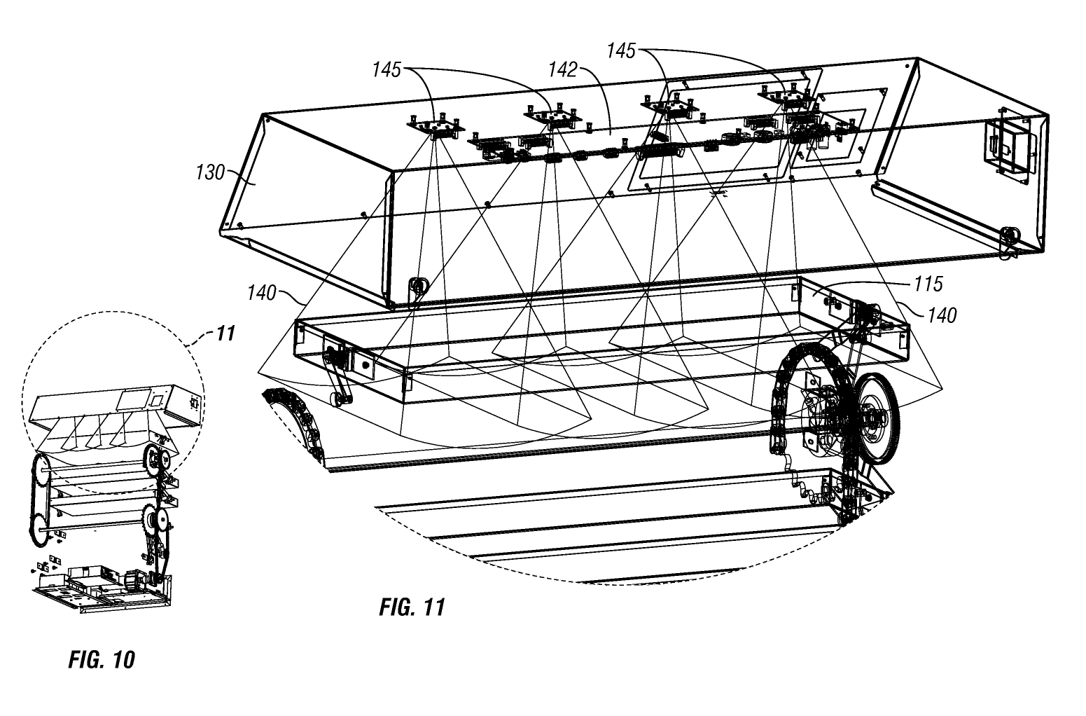

The second special location is located along the back portion of the upper cabinet. This position places the tool tray directly underneath a digital camera system (see FIGS. 10 and 11). This is the Image Capture Position. Four Camera Boards 145 are stored on the upper surface of Upper Cabinet 130. Optionally all four of the Camera Boards 145 may be mounted on a separate mounting panel which is then attached to the upper surface of Upper Cabinet 130. Though this embodiment utilizes four cameras, a larger or smaller number of cameras can be utilized depending on the specific design needs for a particular Tool Control System 100

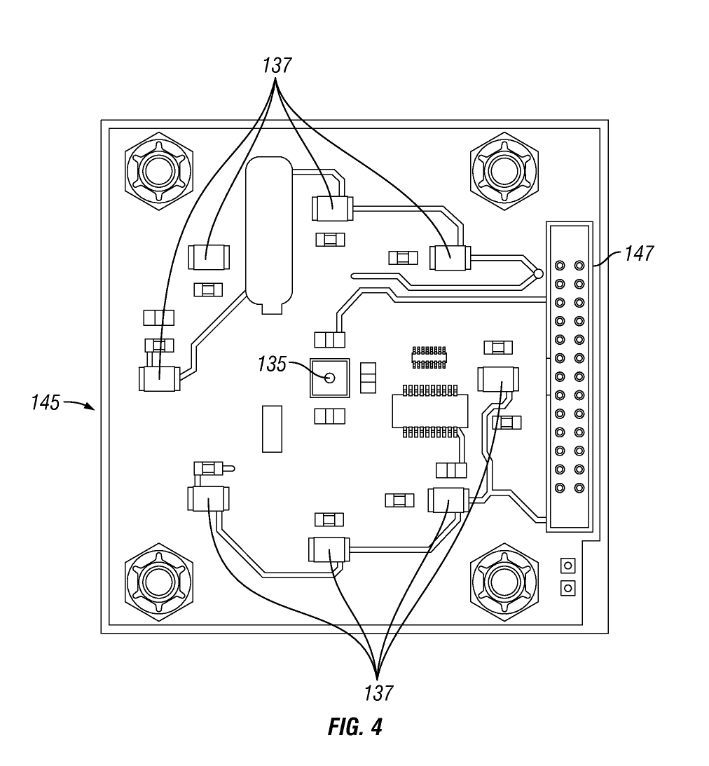

Each Camera Board 145 includes a CCD camera 135 and 8 LEDs 137 (see FIG. 4) which are used to uniformly illuminate Tray 115. All usual operating parameters of both the camera and the light source can be configured as part of the initial setup.

Data and control signals are sent to and from each Camera Board 145 by the Microcontroller Board 145 which is also mounted in the Upper Cabinet 130. In the typical installation, the Microcontroller Board 145 handles all of the initial image processing, user validation and tool validation steps. A standard serial port (not shown) is connected to the microcontroller Board 145 to enable downloading of firmware for the Microcontroller Board 145. A standard Ethernet communication port is also provided for general transfer of all other information to and from the Tool Control System 100.

As shown in FIG. 11, the Field of View 140 of each Camera 135 overlaps at least one of the other Field of Views 140 of one of the other Cameras 135 in such a manner that the every point on the surface of the Tray 115 being examined can be captured by at least one of the Cameras 135.

Each cabinet is designed to hold specific tools in specific locations within specific trays. Once a specific collection and arrangement of tools is decided upon, the two layer foam inserts are made. Typically, cutouts are made within an Upper Foam Layer 175 which is of one (foreground) color. The Upper Foam Layer 175 is then placed upon an uncut Lower Foam Layer 180 of a different color referred to as the shadow color. However, any known method of producing a roughly tool-shaped cavity in a material such that the bottom of the cavity is a different color from the rest of material could be used to prepare the tray inserts.

Though forming cavities within the Upper Foam Layer 175 is preferred, it is possible to simply have a single layer of foam with the tool silhouettes formed in a shadow color. The disadvantage of this option is that the tools would have to be carefully placed each time so that Tool 170 is centrally positioned within the silhouettes. Any means of forming a shadow-colored silhouette and any physical means to facilitate the proper placement of tools within the shadow-colored silhouette is contemplated by the invention.

### Operation of the Tool Control System

After the tray inserts are prepared and placed within the trays, the Tool Control System 100 will capture a series of Empty Reference images. The system moves each empty tray into position under the digital camera assembly, and records digital images of each empty tray. These images will be used as an empty reference against which future images of the tray will be compared.

Tools 170 can now be placed within the various trays either through the Front Maintenance Door 150 or the Access Door 125. With either door opened, tools can be placed individually into the trays in the cavities designed for that tool.

Once the desired tools are stored within a tool control cabinet, a supervisor enters an access code and then directs the system to record one or more full reference images of each tray. The system moves each tray into position under the digital camera assembly, and records digital images of each full tray. These images will be used as a Full Reference against which future images of the tray will be compared.

To retrieve a tool, a user scans through the stored tools by actuating the transport mechanism using two buttons mounted on either side of the Cabinet 110. On the left side is a button that supplies the drive power to the transport mechanism and on the right is a rocker that controls direction that the transport mechanism moves. Placement of the buttons and the requirement that both buttons be activated is a safety feature which nearly eliminates the possibility of hands or fingers being injured while the drive mechanism is moving the trays.

When the user sees the desired tool, the button is released, and the tray movement stops. The user then enters an access code or scans an authorization card and the tool Access Door 125 opens. As soon as the Access Door 125 opens, the Status Light changes to red. It will stay red until an audit cycle has been run.

The user removes the tool or tools that are needed from the tray positioned under the Access Door 125. The user then continues to scan through the other trays while Access Door 125 is still open by actuating the two buttons. After the user is finished removing the needed tools, the user closes the Access Door, which causes it to be relatched.

To return tools to the system, or to retrieve additional tools, the authorized user follows the same procedure—position a desired tray under the access door, open, replace or retrieve tool(s), close access door.

To verify that all tools have been returned, the user or an administrator enters their access code, and directs the system to perform an audit. The system repeats the same process it employed to store a reference image by positioning each tray under the digital camera assembly, and taking one or more digital images of each tray.

But instead of simply storing a new set of images, the system employs a sophisticated verification process using algorithms to compare the audit image to data specially processed and stored data called Areas of Interest. If the new audit image matches the reference image within certain tolerances as determined by the algorithms, the tray is considered verified, meaning that all the tools assigned to that tray are present and in the correct locations.

If all trays pass the verification process, the systems sets the Status Light to green. If any tray does not pass the verification process (meaning that one or more tools assigned to that tray is missing, misplaced and/or misaligned outside of the established tolerances) the system sets the Status Light to flashing red. The user or administrator scans the trays to find the tray with the missing or misaligned tool, replaces or repositions the tool, and runs another verification process.

The onboard computer system not only handles the tool auditing process, but also controls all forms of known user access control, status notification, job costing, accounting and inventory processes and other forms of business and accounting operations.

Input and output modules include but are not limited to keypads, touch screens, magnetic card readers, RFID readers, LED displays and biometric verification modules.

### Tray Transport Mechanism

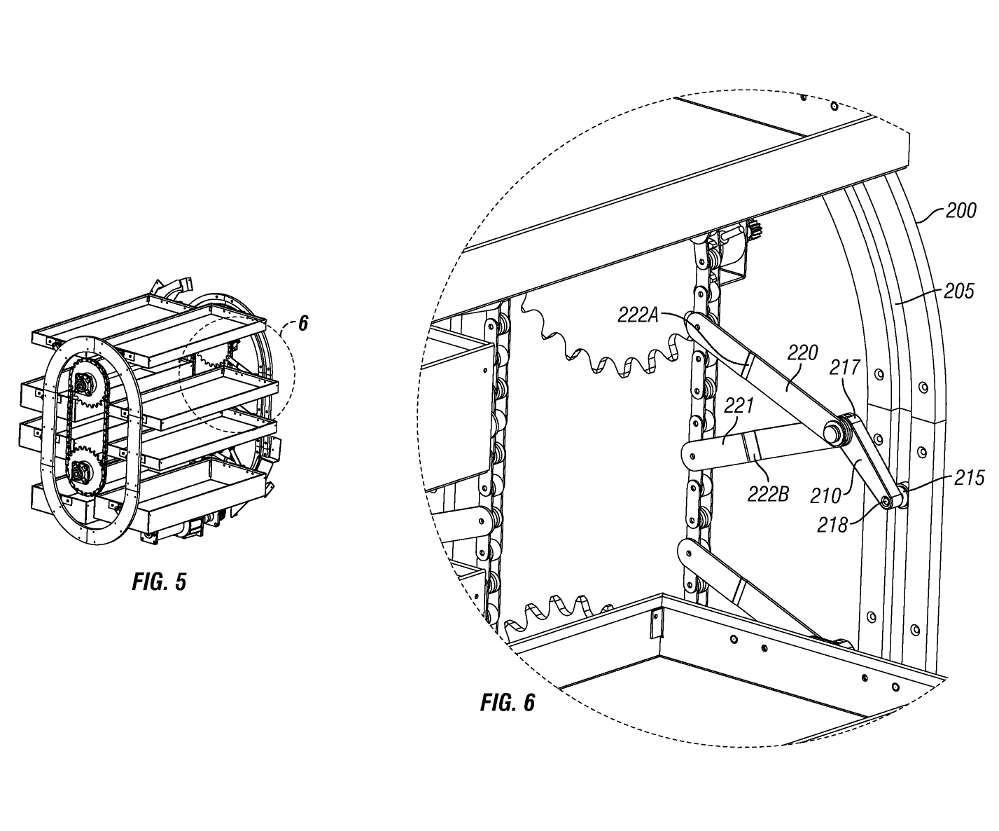

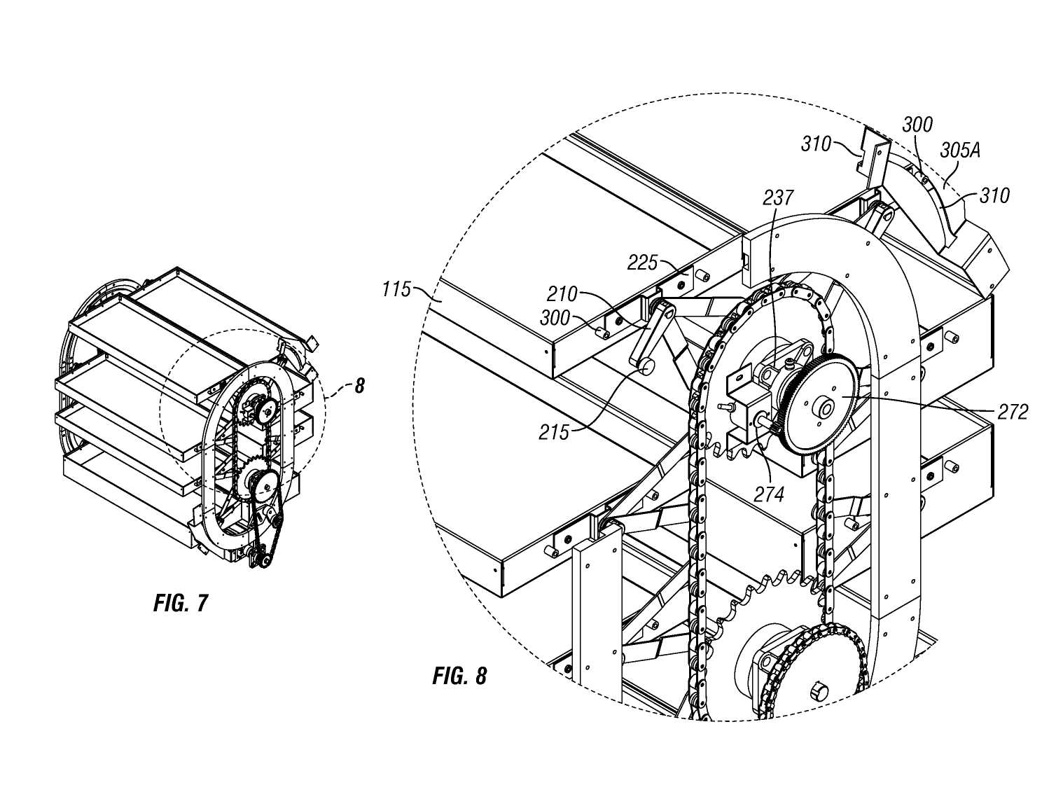

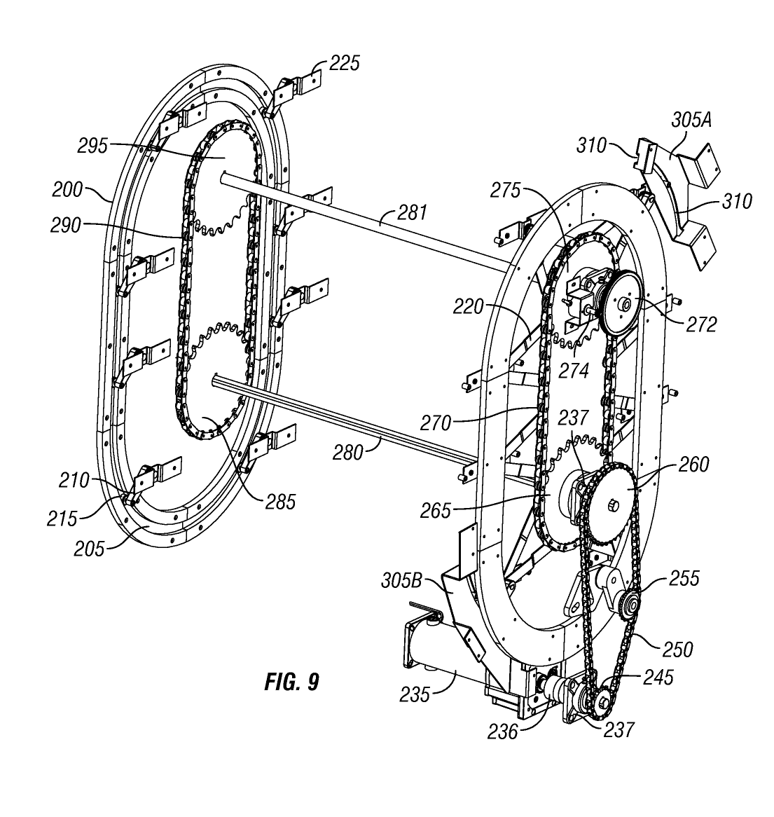

Details of the Tray Transport Mechanism will now be discussed with reference to FIGS. 5-9, where portions of the cabinet walls, floors and other support structures have been removed in order to enhance visibility of the tray transport components.

The are six main elements of the tray transport mechanism. These are 1) grooved oval tracks, 2) a chain drive assembly, 3) a set of trays, 4) a linkage assembly which attaches to the trays, attaches to the driven chains and is stabilized by a roller bearing which rides in the grove of the oval tracks, 5) a positioning system, and 6) a tray stabilization system.

1. Grooved Oval Tracks

A key element is a pair of oval-shaped Roller Tracks 200 which are positioned on each side wall of the Cabinet 110. Roller Bearing Slots 205 are grooves which are centered on the inner surface of each Roller Track 200, the groove running along the entire length of each Roller Track 200.

2. A Chain Drive Assembly

A Lower Drive Shaft 280 and an Upper Drive Shaft 281 are rotatably mounted with a Flanged Bearing Assembly 237 on each end of the Drive Shaft. Further attached on each end of each Drive Shaft 280 are Lower Right Tray Drive Sprocket 265 and Lower Left Tray Drive Sprocket 285. Attached on each end of each Drive Shaft 281 are Upper Right Tray Drive Sprocket 275 and Upper Left Tray Drive Sprocket 295.

The Upper and Lower Right Tray Drive Sprockets 265 and 275 are linked together by the Right Tray Drive Chain 270. The Upper and Lower Left Tray Drive Sprockets 285 and 295 are linked together by the Left Tray Drive Chain 290.

Power to the drive shafts and the sprockets is provided in the following manner. The Drive Motor Assembly 235 is attached to the base of the cabinet. Its output is coupled to the Motor Drive Sprocket 245 through the Solid Coupler 236 and a Flanged Bearing Assembly 237. The Motor Drive Sprocket 245 is mechanically coupled to the Shaft Drive Sprocket 260 by the Motor Drive Chain 250 in conjunction with Idler Pulley Assembly 255.

Because Shaft Drive Sprocket 260 is attached to the right end of the Lower Drive Shaft 280, power from the Motor Drive Assembly 235 is transferred via the Motor Drive Sprocket 245 to the Shaft Drive Sprocket 260 to the Lower Drive Shaft 280 which causes the rotation of the Left and Right Lower Drive Shaft Sprockets which transfers power via the Left and Right Tray Drive Chains to the Upper Left and Upper Right Tray Drive Sprockets respectively.

3. A Set of Trays

The tools stored within the Tool Control System 100 are placed within one or more Trays 115. The Trays 115, in any one cabinet, are all the same length and width. In one embodiment, the Trays 115 can have a depth of 2″ to 6″, typically in the fixed sizes of 2″, 4″ and 6″ in any mix of sizes. The floor of each of Tray 115 contains the two foam layers as described above.

4) A Linkage Assembly

The Trays 115 are transported around the Roller Tracks 200 by being attached to the Left and Right Drive Tray Drive Chains 290 and 270. Each Tray 115 has a Weld Pin Bracket 225 attached to each of the shorter sides of the Tray 115. In the middle of each Weld Pin Bracket 225 there is a U-shaped saddle to which the End 217 of Track Arm 210 is rotatably attached. Tray Arm A 220 and Tray Arm B 221 are also rotatably attached to End 217 of Track Arm 210. The opposite ends of Tray Arm 220 and 221 are attached to either the Left or Right Tray Drive Chain 290, 270. In order for Tray Arm A 220 and Tray Arm B 221 to fit properly on the Tray Drive Chains 290, 270, each Tray Arm has an offset. Tray Arm A 220 has Offset 222A and Tray Arm B has Offset 222B.

5. A Positioning System

One of the Trays 115 is fitted with a magnet which triggers a magnetic switch mounted on the wall of Cabinet 150. This tray is referred to as Tray 1. The system will rotate the trays until Tray 1 triggers the magnetic switch. The magnet and the magnetic sensor are positioned and adjusted so that the magnetic sensor is triggered when Tray 1 is properly positioned under the digital camera assembly. Because Drive Motor Assembly 235 is a stepper motor, the control system can be programmed to send exactly the number of pulses to the Drive Motor Assembly needed to move each tray into the exact same position under the digital camera assembly.

Though the use of a magnetic sensor to identify and position Tray 1 is preferred, other types of positioning mechanisms can be used, including but not limited to microswitches and optical switches.

6. A Tray Stabilization System

Each Tray 115 has two Guide Pins 300, which are located on the short sides of Tray 115 on the right side. The Guide Pins 300 are designed to fit within Guide Bracket Slot 310 which is formed within each of two Guide Brackets 305A and 305B.

Guide Brackets 305A and 305 B are mounted along the upper back and the lower front of the right side Roller Track 200. As the Trays 115 are transported around the Roller Tracks, Guide Pins 300 engage within Guide Bracket Slots 310 which helps to stabilize the trays as they transition from vertical travel to horizontal travel.

Guide Pins also serve the important purpose of positioning Tray 115 in a horizontal position when placed directly under the digital camera assembly. This eliminates the need to perfectly balance tool's weight distribution in Tray 115 along the long axis. With Tray 115 being positioned repetitively in the same horizontal position under the digital camera assembly, significant increases sensitivity can be achieved. The preferred embodiment of the Tool Control System is able to detect the absence of a standard 1/16 inch alien wrench.

### Software Auditing Procedure

The digital color cameras used in the present invention capture a digital image which is 640×480 pixels in size. The bitmapped image that is generated by the digital cameras consists of alternating rows of GRGRGR pixels and BGBGBG pixels. Thus the matrix looks like:
GRGRGR . . . GRGR
BGBGBG . . . BGBG
GRGRGR . . . GRGR
BGBGBG . . . BGBG

Each pixel can have an intensity value of 0-254. This bitmapped image data is then packed or compressed as is now described. Data is processed in groups of four pixels, two from one row and two from the next row below.

The extra green pixel is ignored:

| | | |
|---|---|---|
| GR | GR | GR |
| [symbol] | [symbol] | [symbol] |

Each group of 4 pixels is represented by a single pixel in the packed format.

The intensities of the 3 pixels (one red, one green and one blue) are averaged to give X̅. If only one individual pixel value for this group is above a predetermined threshold over X̅, then this pixel group gets assigned the color that is above the threshold. Thus the pixel in the compressed image file is either red, green or blue. No intensity value is assigned.

If no color in the pixel group is above the threshold over X̅ then the color for that pixel group is assigned as follows:

if X̅>=128 then the pixel group is assigned WHITE

if X̅<128 then the pixel group is assigned BLACK

Each group of 4 pixels is now represented by one pixel value. Thus the full image is now represented by a bitmap of 0-319 pixels columns across and 0-239 pixel rows down.

All images captured by the digital cameras go through this bitmapped image packing which is typically performed onboard by the Microcontroller Board 145 and does not require any processing by an external computer.

The Tool Control System can have one or more digital cameras which capture images of the tool trays. A typical embodiment has four digital cameras with overlapping fields of view (see 140, FIG. 11).

As part of the initial setup, each empty tray and the foam cutouts are positioned under the digital camera assembly and four images of the empty tray are captured. These are the Four Empty Reference images. The process is repeated after each tool has been placed in its proper cavity in its proper tray. This results in Four Full Reference Images captured for each tray. The captured images are processed as described above and stored as individual files.

The user will now generate a number of Areas of Interest which are user-defined rectangular areas which include some portions of the tools being tracked. In order for the user to draw Areas of Interest (AOI), a Color Difference map is generated. The purpose of the Dolor-Difference map is to highlight the tool and any colored tags on the tools.

The pixels from the same corresponding locations in the Empty and Full Reference images are compared and a pixel value is assigned in the Color Difference map at the same location. The value of the pixel in the Color Difference map is assigned based upon the following:

| | |
|---|---|
| If the color of the pixel in the Full | the pixel is assigned the same color. |
| and Empty reference images are | For example, a white foreground |
| the same, then: | ordinarily shouldn't change so if the |
| | pixel is white in the Empty bitmap it |
| | should also be white in the Full |
| | bitmap. Therefore will be white in |
| | the Color Difference map. |
| | Typically, there are portions of the |
| | shadow color in the tool cutout which |
| | aren't covered by the tool. These pixels |
| | would be the same for the Empty and |
| | the Full reference images, so they |
| | would be the shadow color, typically |
| | red, in the Color Difference Map. |
| If there is a difference between | the pixel in the Color Difference Map |
| Empty and Full and the Full is | is the dominant color. |
| NOT black or white (i.e., there is a | |
| dominant color) then: | |
| If there is a difference between | the pixel is assigned a gray color. |
| Empty and Full and the Full pixel | |
| does not have a dominant color | |
| (i.e. the pixel is either White or | |
| Black), then: | |

Thus in the typical setup of a white background and red shadow color and no colored tape on the tool (optional), the Color-Difference Map would only have the colors white, red and gray, with the pixels located over the tool being gray.

If the tool had a blue and/or green tape on it, then the Color-Difference Map would have the colors white, red, gray and either blue and/or green, depending on the color of the tape.

### Areas of Interest (AOI)

With the Color-Difference Map displayed on the monitor, the software allows the user to draw a rectangle on the screen around part of the tool. The user can draw one or more Areas of Interest for any particular tool taking into account the actual shape of the tool which could be a screwdriver, open end wrench, combination wrench, etc.

The software will record the location of the drawn rectangle with reference to the digital camera's bitmapped image, as well as the color counts for the pixels within the AOI. The color counts are calculated as follows.

The Red count is calculated by adding the total number of red pixels to ½ the number of gray pixels. The Green count is calculated by taking ½ the number of green pixels and the Blue count is calculated by taking ½ the number of blue pixels.

The value of ½ is a threshold variable which can be changed by the user, but typically is set to 0.5. The user will perform AOI assignments for any particular choice of tools, which includes multiple AOI per tool, multiple tools per tray and multiple trays per cabinet. The user selects the Color-Difference Map for each digital camera for each tray and assigns one or more AOIs for each tool or part of a tool visible within that digital camera's field of vision. When all AOIs have been designated, the system stores/downloads the data record for each AOI to the onboard microcontroller in the Tool Control System.

7. Validation

Anytime the Tool Control System 10 has allowed controlled access to the tools within it, the Tool Control System 100 will indicate that the system needs validation. During validation, the Tool Control System 100 will transport each tool tray to the Image Capture Position and captures an audit image from each of the cameras in the digital camera assembly.

The data packing as described above is performed on each of the audit images. Then the data from each AOI is compared to the corresponding image data in the audit image.

As an example, the data from the first AOI, which was taken by camera 1, is used and the pixels from the same area in the audit image as defined in the AOI, are totaled to give the number of pixels for Red, Green and Blue for the Audit Image.

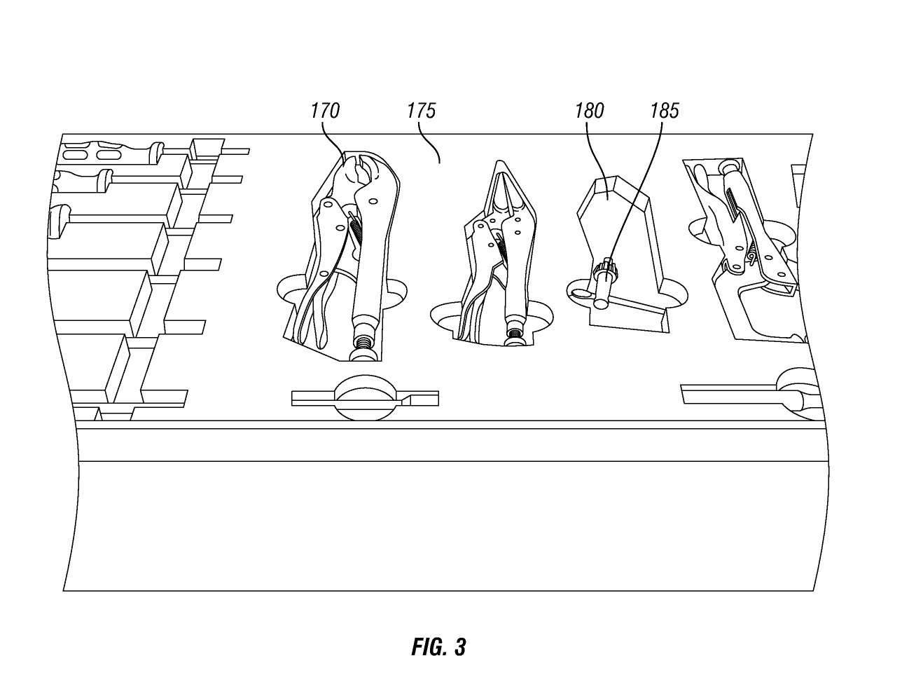

If the Audit Image pixel counts for each color are greater than corresponding color count from the stored values for this AOI, then this AOI is flagged as not being validated. If the Audit Image pixel counts are less than or equal to the color counts stored in the AOI, then the AOI is flagged validated. All of the AOIs for any particular tool must be validated for the tool to be considered as being in its proper position. An example of a Mispositioned Tool 185 is shown in FIG. 3.

If all AOIs are validated then all tools are considered to have been returned to their proper position and the cabinet as a whole is validated. When the cabinet is validated, appropriate auditory and visual signals are initiated to inform the user that the cabinet is validated. In addition, the validation status of the cabinet can be transmitted to a remote location and/or computer by any means of wireless and/or wired digital communication.

Likewise, if any tool has not been validated, then the onboard computer will initiate proper auditory and visual signals, display information about the missing tool and its tray location and transmit the status of the cabinet to a remote location and/or computer by any means of wireless and/or wired digital communication.

8. Non-Conforming Object Detection (NCO)

In addition to detecting the proper re-positioning of the selected tools, the Tool Control System 100 can optionally detect the presence of tools or other objects not intended to be within the Tool Control System 100 as well as tools completely misplaced, that is placed in locations other than completely in the cavities that are intended to be the storage location for the tools.

Even if all of the intended tools are located properly and all of the AOIs are found to be validated, if a non-conforming tool is placed such that it is not within one of the selected AOIs, this non-conforming tool can be detected and the Tool Control System will not be validated.

The process for detecting the non-conforming objects is now described. The packed image files for the Full Reference Image and the audit image are compared and a NCO Color Difference Map is generated. If the corresponding pixels in the Full Reference Image and Audit Image are the same then the corresponding pixel in the NCO Color Difference Map is set to white. If the pixels are different, then the corresponding pixel in the NCO Color Difference Map is set to black.

Next noise is filtered out. Any grouping of 4 black pixels that is not in a 2×2 matrix are filtered out by setting that grouping of pixels to white.

Next all areas that have been defined in an AOI are eliminated from consideration. Then standard edge detection algorithms are used to identify closed areas of black pixels. Then the total number of black pixels within an identified closed area are counted. If the closed area has a total black pixel count above a user defined threshold, then the closed area is considered to represent a foreign object and the status of the Tool Control System is not considered to be validated. The various display and/or output devices incorporated into the Tool Control System can be used to transmit the tray numbers for the locations of any identified foreign objects.

Even though the preferred embodiment as described herein provides for the tool trays to be physically transported into position under the digital camera assembly, it is within the scope of the present invention that the tools would remain stationary and the digital camera assembly would be transported in order to be able to capture images of all the tools or other objects.

This configuration in which the tools remained stationary and the digital camera assembly moved could be incorporated as part of a controlled access stock room. The controlled access stock room would limit physical access into the room and would track which tools were taken and/or returned by scanning the whole room after a user has left the controlled space.

Furthermore, a combination of these two methods is also contemplated wherein both the digital camera assembly would be transported over a tool control tray as well as transporting additional tool trays to a position that they could be scanned by the digital camera assembly.

In one preferred embodiment, initial set up and selection and assignment of AOIs are done through the use of an external computer connected to the Tool Control System. AOI information can then be downloaded to the Tool Control System. This permits the normal post-setup operation of the Tool Control System to be conducted without being attached to an external computer. Mobility is further enhanced by including an independent power system (typically a rechargeable battery system) which would allow the Tool Control System to be wheeled anywhere and used anywhere, even if there is no ready access to normal 110 volt power. This is the most efficient use of resources. One external computer could be used to perform the initial set up for a number of Tool Control Systems because initial setup and/or changing the number and/or types of tools within a Tool Control System is not done very frequently. And the onboard microcontroller would permit the use of the Tool Control System without the having the need for a full computer dedicated to each Tool Control System.

The separation of computing resources between an onboard microcontroller and an external computer is only one option. It is possible to have a full computer built into the Tool Control System or have all computing resources handled by an external computer.

What is claimed is:

1. An article control system comprising:
an article container which is adapted to store one or more articles; said article container having one or more cavities formed within the bottom surface of the article container; the cavity being a shadow color and the non-cavity portions of the bottom surface being a foreground color, said cavity having a general silhouette shape around the article to be stored in that cavity;
a camera assembly which is located above the article container, said camera assembly comprising one or more color cameras whose total field of view covers all of the cavities in the article container;
a computer module comprising a computer and a software module which is adapted to capture, process and store each of the images of each of the cameras of the camera assembly;
said computer system further adapted to allow the storage of image data associated with one or more areas of interest that have been identified for each of the cavities in the article container; said image data of the area of interest being derived from the image data when there is no article stored in a selected cavity covered by the area of interest and the image data of the area of interest when the associated article has been positioned within the cavity which is at least partially covered by the area of interest; and
said computer module further adapted to compare the stored image data for one or more areas of interest to the image data for the same area of the validation image as defined by the area of interest, to determine whether the article has been positioned within the cavity area for that article within the article container.

2. An article control system as described in claim 1 wherein said image data for an area of interest comprises red, green and blue color counts, the coordinates of the area of interest, and an identifier for the area of interest.

3. An article control system as described in claim 2 wherein the determination comprises the steps of:
a) generating a total red, green and blue color count for the corresponding area of the validation image;
b) comparing the red, green, and blue pixel counts for the stored area of interest to the red, green, and blue pixel counts for the corresponding area of the validation image; and
c) determining that the area of interest is validated if each of the red, green and blue color counts of the area of interest of the validation image is greater than or equal to the red, green, and blue color counts of the stored area of interest.

4. An article control system as described in claim 3 further comprising more than one article container and wherein each of said article containers can be physically moved to be fully within the field of view of said camera assembly.

5. An article control system as described in claim 4 wherein said determination is made for each of said areas of interests for each of said article containers.

6. An article control system as described in claim 6 further comprising a signal which is activated when after a determination has been performed for all areas of interest for all article containers that all articles in all article containers have been validated whereby each article is determined to be in the proper designated storage area of the article container.

7. An article control system as described in claim 6 further adapted to detect foreign objects within one of the article containers.

8. An article control system as described in claim 7 wherein said foreign object detection comprises the steps of:
a. generating a NCO difference map;
b. filtering the NCO difference map to remove noise;
c. ignoring the defined areas of interest for the article container;
d. calculate the number of pixels in each contiguous area of black pixels; and
e. compare the number of pixels in a contiguous area and compare that pixel count to a predefined NCO detection threshold; and
f. generate a non-validated status for any tray in which the NCO difference map contains a contiguous are having a pixel count above the NCO detection threshold.

9. An article control system as described in claim 1 wherein the shadow color is any color other than black.

10. An article control system as describe in claim 9 wherein the shadow color is red.

11. An article control system as described in claim 4 wherein access to the article containers is physically controlled by a computer system.

12. An article control system as described in claim 11 wherein access to the article containers is physically limited to authorized users.

13. An article control system as described in claim 11 further comprising user identification elements.

14. An control system as described in claim 13 wherein said user identification element are selected from the group consisting of keys, keypads, biometric identification detectors, bar codes, RFID tags and magnetic cards.
